(19) United States
(12) Patent Application Publication
(10) Pub. No.: US 2013/0105726 A1
(43) Pub. Date: May 2, 2013

(54) HEAT-CONDUCTIVE SILICONE COMPOSITION

(71) Applicants: Kenichi TSUJI, Annaka-shi (JP); Kunihiro Yamada, Takasaki-shi (JP)

(72) Inventors: Kenichi TSUJI, Annaka-shi (JP); Kunihiro Yamada, Takasaki-shi (JP)

(73) Assignee: Shin-Etsu Chemical Co., Ltd., Chiyoda-ku (JP)

(21) Appl. No.: 13/606,061

(22) Filed: Sep. 7, 2012

(30) Foreign Application Priority Data
Oct. 26, 2011 (JP) 2011-234846

(51) Int. Cl. C09K 5/16

(52) U.S. Cl. 252/75

(57) ABSTRACT

A heat-conductive silicone composition that exhibits reduced thermal contact resistance, while also maintaining high overall thermal conductivity. Specifically, a heat-conductive silicone composition comprising silver particles that undergo an exothermic reaction at a temperature of 260° C. or lower. One embodiment of the composition comprises (A) an organopolysiloxane comprising at least two alkenyl groups within each molecule, and having a kinematic viscosity at 25° C. of 10 to 100,000 mm²/s, (B) an organohydrogenpolysiloxane comprising at least two hydrogen atoms bonded to silicon atoms within each molecule, (C) a platinum-based hydrosilylation reaction catalyst, (D) a reaction retarder, (E) silver particles that undergo an exothermic reaction at a temperature of 260° C. or lower, and (F) a heat-conductive filler, other than the component (E), having a thermal conductivity of at least 10 W/m° C.

### BACKGROUND OF THE INVENTION

1. Field of the Invention

The present invention relates to a heat-conductive silicone composition having extremely low thermal resistance.

2. Description of the Prior Art

It is widely known that semiconductor elements generate heat during operation. Because an increase in the temperature of a semiconductor element causes a deterioration in the performance, semiconductor elements must be cooled. Generally, cooling is achieved by installing a cooling member (a heat sink or the like) close to the heat-generating member. If the contact between the heat-generating member and the cooling member is poor, then air can enter between the two members, causing a reduction in the cooling efficiency, and therefore a heat-dissipating grease or heat-dissipating sheet or the like is used for the purpose of improving the closeness of the contact between the heat-generating member and the cooling member (see Patent Documents 1 to 3). In recent years, the amount of heat generated during operation of semiconductors for higher grade equipment such as servers has continued to increase. As the amount of heat generated increases, the heat-dissipating performance required of heat-dissipating materials such as heat-dissipating greases and heat-dissipating sheets also increases. An increase in heat-dissipating performance requires a reduction in the thermal resistance of the heat-dissipating material. Methods of reducing thermal resistance can be broadly classified into methods in which the thermal conductivity of the heat-dissipating material itself is increased, and methods in which the thermal contact resistance is reduced. Methods have been reported in which a metal having a low melting point is added during the preparation of a heat-dissipating grease, and the low-melting point metal is melted during the heating step used for curing the grease, thereby improving the contact with the substrate and lowering the thermal contact resistance (see Patent Documents 4 and 5). However, because the thermal conductivity of the low-melting point metal itself is low, a problem arises in that even though the thermal contact resistance is able to be reduced, the thermal resistance of the overall heat-dissipating material is not significantly reduced. Further, based on similar thinking, a method that uses a solder containing a metal with high thermal conductivity could be considered, but because the thermal conductivity of the solder itself is low, the thermal conductivity of the overall heat-dissipating material is reduced (see Patent Document 6).

### DOCUMENTS OF RELATED ART

### Patent Documents

[Patent Document 1] JP 2,938,428 B

[Patent Document 2] JP 2,938,429 B

[Patent Document 3] JP 3,952,184 B

[Patent Document 4] JP 3,928,943 B

[Patent Document 5] JP 4,551,074 B

[Patent Document 6] JP 07-207160 A

### SUMMARY OF THE INVENTION

The present invention has an object of providing a heat-conductive silicone composition that exhibits reduced thermal contact resistance, while also maintaining high overall thermal conductivity.

The inventors of the present invention selected silver, which has a high thermal conductivity, as the solution to achieving the above object. In particular, they discovered that by using a silver filler that fused at a temperature of 260° C. or lower, fusion between particles of the filler, or fusion between the filler and the substrate, or both these types of fusion, could be achieved during heat curing, thereby reducing the thermal contact resistance and reducing the thermal resistance of the overall heat-dissipating material, and they were therefore able to complete the present invention.

In other words, the present invention provides a heat-conductive silicone composition which comprises silver particles that undergo (i.e. exhibit) an exothermic reaction at a temperature of 260° C. or lower.

In one embodiment of the present invention, the heat-conductive silicone composition comprises:

(A) 100 parts by mass of an organopolysiloxane comprising at least two alkenyl groups within each molecule, and having a kinematic viscosity at 25° C. of 10 to 100,000 mm²/s,

(B) an organohydrogenpolysiloxane comprising at least two hydrogen atoms bonded to silicon atoms within each molecule, in an amount that yields a value for the ratio {number of hydrogen atoms bonded to silicon atoms within the component (B)}/{number of alkenyl groups within the component (A)} that is within a range from 0.5 to 2.0,

(C) an effective amount of a platinum-based hydrosilylation reaction catalyst,

(D) 0.01 to 0.5 parts by mass of a reaction retarder,

(E) 200 to 1,000 parts by mass of silver particles that undergo an exothermic reaction at a temperature of 260° C. or lower, and

(F) 800 to 2,000 parts by mass of a heat-conductive filler, other than the component (E), having a thermal conductivity of at least 10 W/m° C.

The heat-conductive silicone composition of the present invention exhibits reduced thermal contact resistance, and maintains a high overall thermal conductivity. By interposing the heat-conductive silicone composition of the present invention between a heat-generating member and a cooling member, and then performing heat curing at a temperature of 260° C. or lower, the heat generated from the heat-generating member can be diffused efficiently into the cooling member.

### BRIEF DESCRIPTION OF THE DRAWINGS

FIG. 1 is a diagram illustrating a differential scanning calorimetry (DSC) chart for a component E-1 composed of silver particles used in the examples.

FIG. 2 is a diagram illustrating a DSC chart for a component E-2 composed of silver particles used in the examples.

### DESCRIPTION OF THE EMBODIMENTS

The present invention is described below in further detail.

[Silver Particles that Undergo an Exothermic Reaction at 260° C. or Lower]

Details relating to the silver particles used in the present invention, which undergo an exothermic reaction at a temperature of 260° C. or lower, are described below. A single type of these silver particles may be used alone, or a combination of two or more types of silver particles may be used.

Various solders containing silver and having a melting point of 260° C. or lower have already been reported. However, these materials have low thermal conductivity, and do not satisfy the objective of the present invention. For example, as is evident from the fact that a Sn—Ag—Cu system has a melting point of 218° C. and a thermal conductivity of 55 (W/mK), and a Sn—Bi—Ag system has a melting point of 138° C. and a thermal conductivity of 21 (W/mK), although both systems have low melting points, their thermal conductivity values are not high. In contrast, it is known that simple silver has an extremely high thermal conductivity of 427 (W/mK). Until recently, normal silver powders did not fuse unless heated to temperatures of 500° C. or higher.

However, in recent years, silver powders that undergo fusion at temperatures of 260° C. or lower have been reported. It is thought that this phenomenon occurs because the combination of silver compounds produced at the surface of the silver powder and the reduction effect of residual treatment agent remaining on the surface of the powder causes silver to be generated at the powder surface via a reduction reaction, with fusion then occurring between the produced particles. Heat generation is observed when fusion occurs within these types of silver powders. It is thought that this heat generation is due to the reaction mentioned above.

Silver particles that undergo an exothermic reaction at a temperature of 260° C. or lower have the high thermal conductivity of 427 (W/mK) observed for simple silver, and therefore the composition of the present invention that contains these types of silver particles, and cured products obtained from the composition, exhibit a high overall thermal conductivity. Further, because silver particles that undergo an exothermic reaction at a temperature of 260° C. or lower exhibit a lower fusion temperature than normal silver, they melt during the heating step(s) performed during semiconductor production, and therefore the closeness of the contact between a substrate and a cured product obtained from the composition of the present invention can be improved, meaning the thermal contact resistance can be reduced.

If the temperature at which the silver particles undergo an exothermic reaction exceeds 260° C., then because the heat-conductive silicone composition is not exposed to that type of temperature during the semiconductor production process, fusion does not occur. Consequently, the temperature at which the exothermic reaction occurs is typically 260° C. or lower, and preferably 250° C. or lower. In order to ensure that fusion does not occur until heat curing of the composition, the temperature at which the exothermic reaction occurs is preferably at least 90° C., and more preferably 100° C. or higher.

In the present invention, a determination as to whether any particular silver particles undergo an exothermic reaction at a temperature of 260° C. or lower can be confirmed easily by observing whether or not the silver particles have an exothermic peak at 260° C. or lower in a differential scanning calorimetry (DSC) measurement. Exothermic peaks can be observed by performing DSC using a Mettler Toledo DSC820 apparatus at a rate of temperature increase of 10° C./minute.

### [Component (A)]

The organopolysiloxane of the component (A) contains at least two alkenyl groups bonded to silicon atoms within each molecule. A single compound may be used alone as the component (A), or a combination of two or more compounds may be used. The component (A) may be linear or branched, or may be a mixture of two or more compounds having different viscosities. Examples of the alkenyl groups include vinyl groups, allyl groups, 1-butenyl groups and 1-hexenyl groups, but in terms of ease of synthesis and cost, vinyl groups are preferred. Examples of the remaining organic groups that are bonded to silicon atoms include alkyl groups such as a methyl group, ethyl group, propyl group, butyl group, hexyl group and dodecyl group; aryl groups such as a phenyl group; aralkyl groups such as a 2-phenylethyl group and 2-phenylpropyl group; and substituted monovalent hydrocarbon groups such as halogen-substituted monovalent hydrocarbon groups (such as a chloromethyl group and 3,3,3-trifluoropropyl group). Among these groups, in terms of ease of synthesis and cost, methyl groups are preferred. The alkenyl groups bonded to silicon atoms may exist at either the terminals of the molecular chain of the organopolysiloxane, or at non-terminal positions within the molecular chain, but preferably exist at least at the terminals. If the kinematic viscosity at 25° C. is lower than 10 mm²/s, then the storage stability of the composition may deteriorate, whereas if the kinematic viscosity is greater than 100,000 mm²/s, then the extensibility of the obtained composition may worsen, and therefore the kinematic viscosity is typically within a range from 10 to 100,000 mm²/s, and preferably from 100 to 50,000 mm²/s.

### [Component (B)]

The organohydrogenpolysiloxane of the component (B) must contain at least two hydrogen atoms bonded to silicon atoms (namely, Si—H groups) within each molecule in order to enable the composition to be converted to a network-like structure by cross-linking. A single compound may be used alone as the component (B), or a combination of two or more compounds may be used. Examples of the remaining organic groups that are bonded to silicon atoms include alkyl groups such as a methyl group, ethyl group, propyl group, butyl group, hexyl group and dodecyl group; aryl groups such as a phenyl group; aralkyl groups such as a 2-phenylethyl group and 2-phenylpropyl group; substituted monovalent hydrocarbon groups such as halogen-substituted monovalent hydrocarbon groups (such as a chloromethyl group and 3,3,3-trifluoropropyl group); and epoxy ring-containing organic groups such as a 2-glycidoxyethyl group, 3-glycidoxypropyl group and 4-glycidoxybutyl group. The organohydrogenpolysiloxane of the component (B) may be linear, branched or cyclic, or a mixture thereof. The amount added of the component (B) is an amount that yields a value for the ratio of the number of Si—H groups within the component (B) relative to the number of alkenyl groups within the component (A), namely the ratio {number of hydrogen atoms bonded to silicon atoms within the component (B)}/{number of alkenyl groups within the component (A)} that is within a range from 0.5 to 2.0, and preferably from 0.5 to 1.8. If the amount of the component (B) yields a value for this ratio that is less than 0.5, then a satisfactory network-like structure is difficult to form, and inadequate curing becomes more likely, meaning the composition is undesirable from a reliability perspective. If the amount of the component (B) yields a value for the above ratio that is greater than 2.0, then the cured material is prone to becoming too hard, and achieving satisfactory flexibility is difficult.

### [Component (C)]

The platinum-based hydrosilylation reaction catalyst of the component (C) is a component for accelerating the addition reaction between the alkenyl groups of the component (A) and the Si—H groups of the component (B). A single catalyst may be used alone as the component (C), or a combination of two or more catalysts may be used. The component (C) is a catalyst selected from the group consisting of platinum and platinum compounds, and examples include simple platinum, chloroplatinic acid, platinum-olefin complexes, platinum-alcohol complexes and platinum coordination compounds. The amount added of the component (C) need only be sufficient to provide an effective amount as a hydrosilylation catalyst. Reported as a mass of platinum atoms relative to the mass of the component (A), the amount is preferably within a range from 0.1 to 500 ppm. Provided the amount of the component (C) satisfies this range, the size of the catalytic effect can be readily increased by increasing the amount of the catalyst, and the amount is also economically viable.

### [Component (D)]

The reaction retarder of the component (D) suppresses progression of the hydrosilylation reaction at room temperature, and is used for extending the shelf life or pot life. A single compound may be used alone as the component (D), or a combination of two or more compounds may be used. Conventional compounds can be used as the reaction retarder, and examples of compounds that may be used include acetylene compounds, various nitrogen compounds, organophosphorus compounds, oxime compounds and organochlorine compounds. If the amount added of the component (D) is less than 0.01 parts by mass, then achieving satisfactory shelf life or pot life becomes difficult, whereas if the amount exceeds 0.5 parts by mass, the curability tends to worsen, and therefore the amount is typically within a range from 0.01 to 0.5 parts by mass. In order to improve the dispersibility of the component (D) within the silicone resin, the component (D) may be diluted with toluene or the like prior to use.

### [Component (E)]

The component (E) is the same as the silver particles that undergo an exothermic reaction at a temperature of 260° C. or lower described above. A single type of silver particles may be used alone as the component (E), or a combination of two or more types of silver particles may be used.

The average particle size of the component (E) is preferably within a range from 0.1 to 100 μm. Provided the average particle size satisfies this range, the obtained composition is readily converted to grease form, and is more likely to exhibit superior properties of extensibility and uniformity. In the present invention, the average particle size refers to a volume-based value that can be measured using a Microtrac MT3300EX device manufactured by Nikkiso Co., Ltd. The shape of the component (E) may be amorphous, spherical, or any other shape. The amount added of the component (E) is typically within a range from 200 to 1,000 parts by mass per 100 parts by mass of the component (A). If this amount is less than 200 parts by mass, then because satisfactory fusion between the silver particles does not occur, the desired low thermal resistance is difficult to achieve, whereas if the amount exceeds 1,000 parts by mass, then the resulting composition is difficult to convert to grease form, and tends to exhibit inferior extensibility. The amount is preferably within a range from 200 to 800 parts by mass.

### [Component (F)]

Fillers having a thermal conductivity of at least 10 W/m° C. may be used as the heat-conductive filler of the component (F). If the thermal conductivity of the component (F) is less than 10 W/m° C., then the thermal conductivity of the overall resulting composition may decrease. A single filler may be used alone as the component (F), or a combination of two or more fillers may be used. Examples of the heat-conductive filler of the component (F) include aluminum powder, copper powder, silver powder other than the component (E), nickel powder, gold powder, metallic silicon powder, aluminum nitride powder, boron nitride powder, alumina powder, diamond powder, carbon powder, indium powder and gallium powder, but any filler other than the component (E) having a thermal conductivity of at least 10 W/m° C. may be used, and the filler may contain a single material, or a mixture of two or more types of material.

The average particle size of the component (F) is preferably within a range from 0.1 to 100 μm. Provided the average particle size satisfies this range, the obtained composition is readily converted to grease form, and is more likely to exhibit superior properties of extensibility and uniformity. The shape of the component (F) may be amorphous, spherical, or any other shape.

The amount added of the component (F) is typically within a range from 800 to 2,000 parts by mass, preferably from 800 to 1,800 parts by mass, and more preferably from 800 to 1,500 parts by mass, per 100 parts by mass of the component (A). If this amount is less than 800 parts by mass, then obtaining a composition having the desired thermal conductivity is difficult, whereas if the amount exceeds 2,000 parts by mass, then the resulting composition is difficult to convert to grease form, and tends to exhibit inferior extensibility.

### [Component (G)]

Component (G) which is an organosilane represented by general formula (1) shown below:

R¹ₐR²_{b}Si(OR³)_{4-a-b} (1)

wherein R¹ represents an alkyl group of 9 to 15 carbon atoms, R² represents a monovalent hydrocarbon group of 1 to 8 carbon atoms, R³ represents an alkyl group of 1 to 6 carbon atoms, a represents an integer of 1 to 3, b represents an integer of 0 to 2, and a+b is an integer of 1 to 3, may be optionally added to the composition.

The component (G) is used as a wetter. A single compound may be used alone as the component (G), or a combination of two or more compounds may be used.

Specific examples of R¹ in the above general formula include a nonyl group, decyl group, dodecyl group and tetradecyl group. If the number of carbon atoms is less than 9, then the wettability between the component (G) and the fillers is inadequate, whereas if the number of carbon atoms is more than 15, then the organosilane solidifies at normal temperatures, which is inconvenient in terms of handling properties, and also causes a deterioration in the low-temperature properties of the obtained composition. Further, a may be 1, 2 or 3, but is preferably 1. Furthermore, in the above formula, R² represents a monovalent hydrocarbon group of 1 to 8 carbon atoms, and may be a saturated monovalent hydrocarbon group or an unsaturated monovalent hydrocarbon group. Examples of R² include monovalent hydrocarbon groups such as alkyl groups, cycloalkyl groups; alkenyl groups; aryl groups; aralkyl groups; and halogenated monovalent hydrocarbon groups. More specific examples include alkyl groups such as a methyl group, ethyl group, propyl group, hexyl group and octyl group; cycloalkyl groups such as a cyclopentyl group and cyclohexyl group; alkenyl groups such as a vinyl group and allyl group; aryl groups such as a phenyl group and tolyl group; aralkyl groups such as a 2-phenylethyl group and 2-methyl-2-phenylethyl group; and halogenated monovalent hydrocarbon groups such as a 3,3,3-trifluoropropyl group, 2-(perfluorobutyl)ethyl group, 2-(perfluorooctyl)ethyl group and p-chlorophenyl group. Among these, a methyl group and an ethyl group are particularly desirable. R³ represents an alkyl group of 1 to 6 carbon atoms such as a methyl group, ethyl group, propyl group, butyl group, pentyl group and hexyl group, and a methyl group and an ethyl group are particularly desirable.

Specific examples of the component (G) include the compounds listed below.

C₁₀H₂₁Si(OCH₃)₃, C₁₂H₂₅Si(OCH₃)₃, C₁₂H₂₅Si(OC₂H₅)₃, C₁₀H₂₁Si(CH₃)(OCH₃)₂, C₁₀H₂₁Si(C₆H₅)(OCH₃)₂, C₁₀H₂₁Si(CH₃)(OC₂H₅)₂, C₁₀H₂₁Si(CH═CH₂)(OCH₃)₂, and C₁₀H₂₁Si(CH₂CH₂CF₃)(OCH₃)₂

In those cases where the component (G) is added, increasing the amount added above 10 parts by mass per 100 parts by mass of the component (A) yields no further effect, and is uneconomic. Accordingly, the amount added of the component (G) is preferably within a range from 0.1 to 10 parts by mass, and more preferably from 0.1 to 8 parts by mass.

### [Other Components]

In addition to the components (A) to (G) described above, if required the composition of the present invention may also include, as other optional components, an adhesion assistant and an antioxidant or the like for preventing degradation of the composition. A single compound may be used alone as an optional component, or a combination of two or more compounds may be used.

### [Production Method]

The composition of the present invention can be produced by mixing the components (A) to (F), together with the component (G) and any other optional components, using a mixer such as a Trimix, Twinmix or Planteary Mixer (all registered trademarks for mixers manufactured by Inoue Manufacturing Co., Ltd.), an Ultramixer (a registered trademark for a mixer manufactured by Mizuho Industrial Co., Ltd.), or a Hivis Disper Mix (a registered trademark for a mixer manufactured by Primix Corporation).

### EXAMPLES

The present invention is described below in further detail based on a series of examples and comparative examples.

Tests relating to the effects of the present invention were performed in the manner described below.

### [Viscosity Measurement]

The absolute viscosity of the grease-like composition prior to curing was measured at 25° C. using a Malcolm viscometer (type: PC-1T).

### [Thermal Conductivity Measurement]

The thermal conductivity was measured at 25° C. using a Quick Thermal Conductivity Meter QTM-500 (manufactured by Kyoto Electronics Manufacturing Co., Ltd.).

### [Thermal Resistance Measurement]

The silicone composition was sandwiched between two circular aluminum plates having a diameter of 12.7 mm to prepare a test piece for measuring the thermal resistance, and the thermal resistance was then measured. The thermal resistance was measured under two sets of conditions, namely (A) (following heating at 150° C. for 90 minutes), and (B) (following heating at 150° C. for 90 minutes, and then at 260° C. for 5 minutes). These thermal resistance measurements were performed using a Nanoflash device (LFA447, manufactured by Netzsch Group).

The components listed below were used in forming the various compositions.

### Component (A)

A-1: a dimethylpolysiloxane having both terminals blocked with dimethylvinylsilyl groups and having a viscosity at 25° C. of 600 mm²/s.

### Component (B)

Organohydrogenpolysiloxanes represented by formula shown below.

B-1: an organohydrogenpolysiloxane represented by a formula shown below.

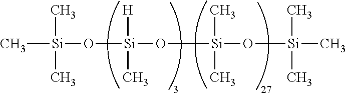

B-2: an organohydrogenpolysiloxane represented by a formula shown below.

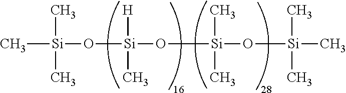

B-3: an organohydrogenpolysiloxane represented by a formula shown below.

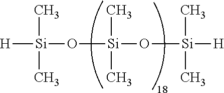

### Component (C)

C-1: an A-1 solution of a platinum-divinyltetramethyldisiloxane complex (containing 1% by mass of platinum atoms).

### Component (D)

D-1: a 50% by mass toluene solution of 1-ethynyl-1-cyclohexanol.

### Component (E)

E-1: silver particles having an average particle size of 7.5 μm and having an exothermic peak at 210° C.

E-2: silver particles having an average particle size of 2 μm and having an exothermic peak at 180° C.

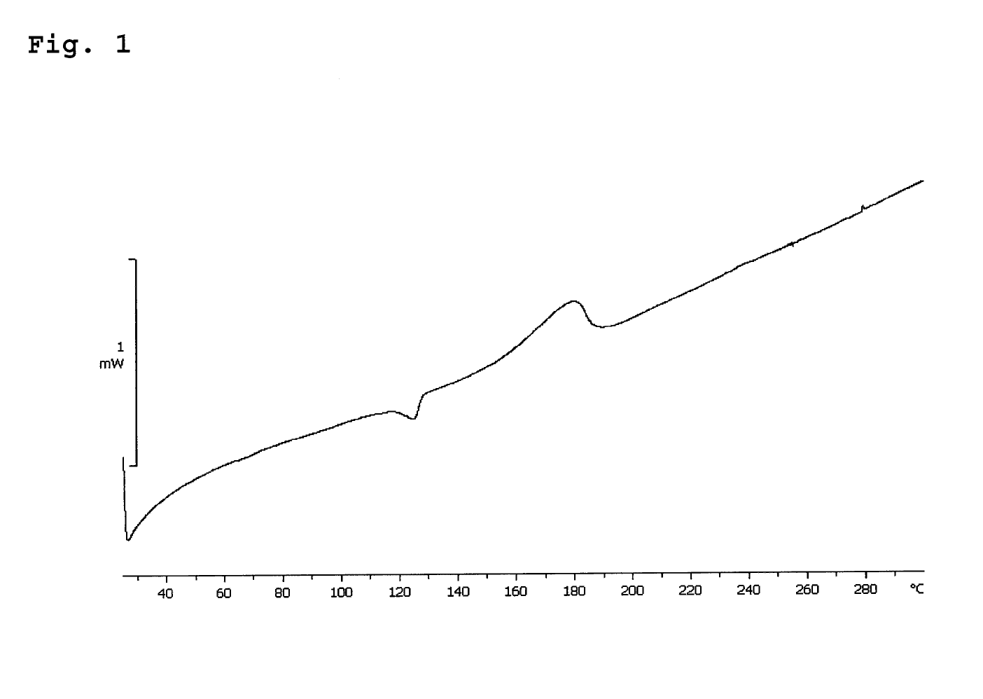

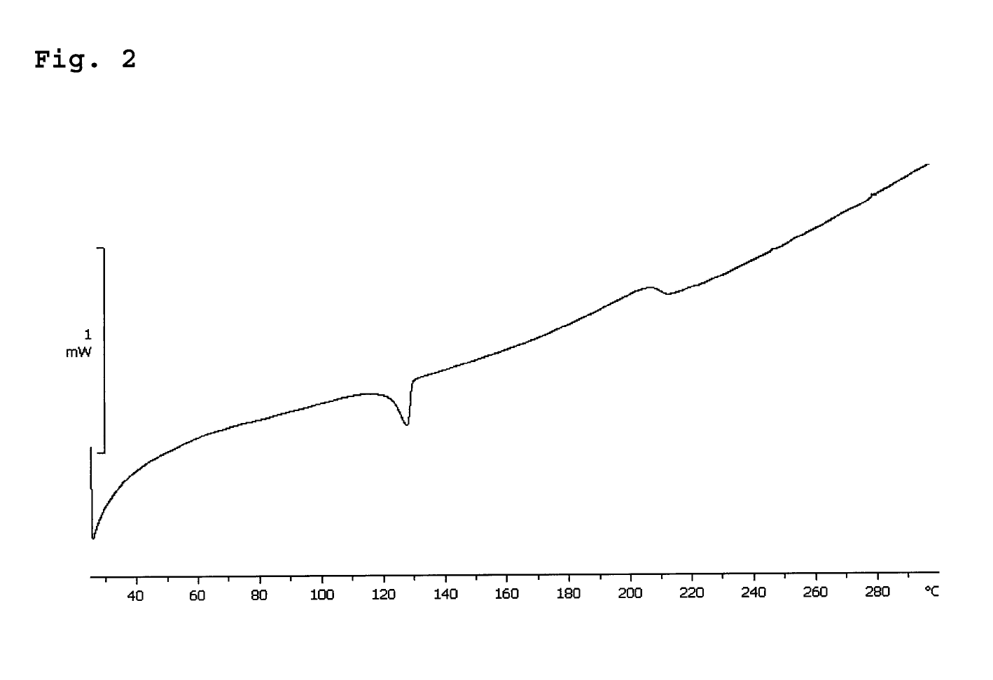

The DSC charts of the components E-1 and E-2 are shown in FIG. 1 and FIG. 2 respectively.

### Component (F)

F-1: silver particles having an average particle size of 5 μm and not having an exothermic peak at 260° C. or lower (thermal conductivity: 427 (W/mK)).

F-2: an aluminum powder having an average particle size of 10 μm (thermal conductivity: 237 (W/mK)).

F-3: an Sn—Ag—Cu alloy powder having an average particle size of 30 μm (thermal conductivity: 55 (W/mK)).

F-4: an Sn—Bi—Ag alloy powder having an average particle size of 30 μm (thermal conductivity: 21 (W/mK)).

### Component (G)

G-1: an organosilane represented by a formula shown below.

C₁₀H₂₁Si(OCH₃)₃

The components (A) to (G) were mixed in the formulations shown below, yielding compositions of examples 1 to 7 and comparative examples 1 to 4. Specifically, the components (A), (E), (F) and (G) were placed in a 5-liter Planetary Mixer (manufactured by Inoue Manufacturing Co., Ltd.) in the amounts shown below in Table-1 and Table-2, and were mixed at 70° C. for one hour. Subsequently, the mixture was cooled to room temperature, and the components (B), (C) and (D) were added and mixed in the amounts shown in Table-1 and Table-2. The numerical values for each component listed in Table-1 and Table-2 represent parts by mass.

TABLE 1

| | Example | | | | | | |
|---|---|---|---|---|---|---|---|
| Units: parts by mass | 1 | 2 | 3 | 4 | 5 | 6 | 7 |
| A-1 | 100 | 100 | 100 | 100 | 100 | 100 | 100 |
| B-1 | 4.6 | 4.6 | 4.6 | | 4.6 | 4.6 | 4.6 |
| B-2 | | | | 0.7 | | | |
| B-3 | 6.6 | 6.6 | 6.6 | 9.7 | 6.6 | 6.6 | 6.6 |
| C-1 | 0.15 | 0.15 | 0.15 | 0.15 | 0.15 | 0.15 | 0.15 |
| D-1 | 0.45 | 0.45 | 0.45 | 0.45 | 0.45 | 0.45 | 0.45 |
| E-1 | 270 | | 150 | 270 | 270 | 270 | 300 |
| E-2 | | 270 | 120 | | | | |
| F-1 | 810 | 810 | 810 | 810 | | 540 | 900 |
| F-2 | | | | | 1000 | 360 | |
| F-3 | | | | | | | |
| F-4 | | | | | | | |
| G-1 | | | | | | | 6 |
| Ratio of Si—H/Si-alkenyl | 1.0 | 1.0 | 1.0 | 1.1 | 1.0 | 1.0 | 1.0 |
| Viscosity (Pa · s) | 202 | 301 | 224 | 212 | 407 | 348 | 331 |
| Thermal conductivity (W/mK) | 3.9 | 3.8 | 4.0 | 4.1 | 4.0 | 3.9 | 3.8 |
| Thermal resistance (A) (mm²K/W) | 7.6 | 7.8 | 7.4 | 7.5 | 7.7 | 7.9 | 8.0 |
| Thermal resistance (B) (mm²K/W) | 3.9 | 3.7 | 4.0 | 4.0 | 4.8 | 4.1 | 3.8 |

TABLE 2

| | Comparative example | | | |
|---|---|---|---|---|
| Units: parts by mass | 1 | 2 | 3 | 4 |
| A-1 | 100 | 100 | 100 | 100 |
| B-1 | 4.6 | 4.6 | | 4.6 |
| B-2 | | | 0.6 | |
| B-3 | 6.6 | 6.6 | 8.8 | 6.6 |
| C-1 | 0.15 | 0.15 | 0.15 | 0.15 |
| D-1 | 0.45 | 0.45 | 0.45 | 0.45 |
| E-1 | | | | |
| E-2 | | | | |
| F-1 | 1080 | 810 | 1080 | 810 |
| F-2 | | | | |
| F-3 | | 270 | | |
| F-4 | | | | 270 |
| G-1 | | | | |
| Ratio of Si—H/Si-alkenyl | 1.0 | 1.0 | 1.0 | 1.0 |
| Viscosity (Pa · s) | 102 | 105 | 104 | 104 |
| Thermal conductivity (W/mK) | 4.0 | 2.9 | 4.1 | 4.1 |
| Thermal resistance (A) (mm²K/W) | 7.7 | 11.1 | 7.7 | 14.3 |
| Thermal resistance (B) (mm²K/W) | 7.4 | 8.3 | 7.3 | 10.1 |

What is claimed is:

1. A heat-conductive silicone composition, comprising silver particles that undergo an exothermic reaction at a temperature of 260° C. or lower.

2. The heat-conductive silicone composition according to claim 1, comprising:
(A) 100 parts by mass of an organopolysiloxane comprising at least two alkenyl groups within each molecule, and having a kinematic viscosity at 25° C. of 10 to 100,000 mm²/s,
(B) an organohydrogenpolysiloxane comprising at least two hydrogen atoms bonded to silicon atoms within each molecule, in an amount that yields a value for a ratio {number of hydrogen atoms bonded to silicon atoms within component (B)}/{number of alkenyl groups within component (A)} that is within a range from 0.5 to 2.0,
(C) an effective amount of a platinum-based hydrosilylation reaction catalyst,
(D) 0.01 to 0.5 parts by mass of a reaction retarder,
(E) 200 to 1,000 parts by mass of silver particles that undergo an exothermic reaction at a temperature of 260° C. or lower, and
(F) 800 to 2,000 parts by mass of a heat-conductive filler, other than component (E), having a thermal conductivity of at least 10 W/m° C.

3. The heat-conductive silicone composition according to claim 2, further comprising:
(G) 0.1 to 10 parts by mass, per 100 parts by mass of component (A), of an organosilane represented by general formula (1) shown below:
R¹ₐR²_{b}Si(OR³)_{4-a-b} (1)
wherein R¹ represents an alkyl group of 9 to 15 carbon atoms, R² represents a monovalent hydrocarbon group of 1 to 8 carbon atoms, R³ represents an alkyl group of 1 to 6 carbon atoms, a represents an integer of 1 to 3, b represents an integer of 0 to 2, and a+b is an integer of 1 to 3.
